(19) United States
(12) Patent Application Publication
(10) Pub. No.: US 2026/0097369 A1
(43) Pub. Date: Apr. 9, 2026

(54) NANOFIBER MEMBRANE WITH DUAL-SCALE POROSITY AND METHOD OF FABRICATING THE SAME

(71) Applicant: Nano and Advanced Materials Institute Limited, Hong Kong (HK)

(72) Inventors: Arthur Hong-Kin KWONG, Hong Kong (HK); Huajia DIAO, Hong Kong (HK); Yu TING, Hong Kong (HK); Kaiwei WANG, Hong Kong (HK); Wing Man CHAN, Hong Kong (HK)

(21) Appl. No.: 19/228,804

(22) Filed: Jun. 5, 2025

Related U.S. Application Data
(60) Provisional application No. 63/704,547, filed on Oct. 7, 2024.

(51) Int. Cl. B01D 67/00

(52) U.S. Cl. CPC B01D 67/0011; B01D 67/00091; B01D 2323/219; B01D 2323/39; B01D 2325/02832; B01D 2325/02833

(57) ABSTRACT

The present invention provides a nanofiber membrane with dual-scale porosity, fabricated through a phase-separation electrospinning process. The membrane consists of interconnected inter-fiber and surface pores, enhancing air permeability, diffusion rates, and filtration performance. The method employs solvents with distinct evaporation rates to induce phase separation during electrospinning, resulting in a highly porous structure. The nanofiber membrane is applicable in air filtration, medical dressings, drug delivery systems, and diagnostic test strips, offering improved performance characteristics such as reduced pressure drop, enhanced diffusion, and increased sensitivity in diagnostics. The process enables scalable, cost-effective production with consistent fiber morphology.

### CROSS-REFERENCE TO RELATED APPLICATIONS

The present application claims the priorities from the U.S. provisional patent application Ser. No. 63/704,547 filed Oct. 7, 2024, and the disclosure of which is incorporated herein by reference in its entirety.

### FIELD OF THE INVENTION

The present invention generally relates to the field of Nanotechnology, particularly to the formulation and fabrication of dual-scale porous nanofibers.

### BACKGROUND OF THE INVENTION

Nanofibers have gained widespread use in various applications, including air filtration, diagnostic devices, wound healing, and drug delivery systems. These materials are valued for their high surface area, porosity, and tuneable properties. However, conventional nanofibers suffer from several limitations, which restrict their effectiveness across different fields. For instance, traditional nanofibers typically have dense surfaces with small surface porosity. This absence of surface pores significantly reduces the active surface area available for applications such as filtration and controlled release. In filtration, this results in higher pressure drops, as air or liquid must pass through tightly packed fibers. In controlled-release systems, the lack of surface porosity hinders the diffusion of active ingredients, leading to slower release rates.

For applications such as lateral flow diagnostic strips, conventional nanofibers do not offer adequate surface area to promote fast capillary action or sufficient sensitivity. In these systems, a higher surface porosity would allow more rapid diffusion of the testing fluid, enhancing the sensitivity and specificity of diagnostic results. Current materials often require additional modifications or layers to enhance diffusion, complicating the manufacturing process and adding to production costs.

While nanofibers can be tailored for specific applications, conventional manufacturing methods often involve multiple steps, such as post-fabrication surface treatments or the use of complex materials to enhance porosity. These additional steps increase manufacturing time and cost, making it challenging to scale up production for industrial applications.

Through these challenges, it is evident that there is a need for advanced nanofiber structures with enhanced porosity and performance in various applications.

### SUMMARY OF THE INVENTION

This invention addresses these shortcomings of conventional nanofibers by providing a nanofiber membrane with both surface and inter-fiber porosity using a one-step electrospinning process.

The present invention offers a novel nanofiber material with dual-scale porosity, specifically designed for use in filtration, diagnostic lateral flow strips, and active ingredient release systems. The membrane contains interconnected inter-fiber pores and surface pores, resulting in improved filtration efficiency, lower pressure drops, and enhanced diffusion rates. The invention also offers a simplified manufacturing process.

In one aspect, the present invention provides a nanofiber membrane with dual-scale porosity, it contains one or more dual-scale porous nanofibers. Each dual-scale porous nanofiber has a fiber body having a continuous porous network with interconnected inter-fiber pores and fiber surface pores. The inter-fiber pores are distributed throughout the fiber body, and the surface pores are located on the outer surface of the fiber body. The inter-fiber pores and fiber surface pores exhibit a uniform size distribution, ranging from 100-900 nm and 1-100 nm, respectively.

In one aspect, the one or more dual-scale porous nanofibers are produced from a formulation, by weight, including 45-90% of water-immiscible solvent, 5-45% of water-miscible solvent, and 5-20% of base polymer.

In one aspect, the water-immiscible solvent and the water-miscible solvent have distinct boiling points. The water-immiscible solvent has a boiling point ranging from 40-80° C., and the water-miscible solvent has a boiling point ranging from 60-200° C.

The water-immiscible solvent includes chloroform, dichloromethane, tetrahydrofuran, methyl ethyl ketone, or a combination thereof. The water-miscible solvent includes methanol, ethanol, isopropanol, dimethylformamide, acetone, dimethyl sulfoxide, formic acid, acetic acid, 1,1,1,3,3,3-hexafluoro-2-propanol, or a combination thereof. The base polymer includes polylactic acid (PLA), polyvinylidene fluoride (PVDF), polycaprolactone, polyvinyl butyral, polystyrene (PS), polyacrylonitrile (PAN), or a combination thereof.

In one aspect, the specific area of the one or more dual-scale porous nanofibers is at least 30 m²/g.

In one aspect, the one or more dual-scale porous nanofibers are formed via needle-less electrospinning.

In one aspect, the nanofiber membrane is configured as a wound dressing, enhancing absorption of wound exudate and promoting healing.

In one aspect, the nanofiber membrane is used in a drug delivery system for controlled release of pharmaceutical compounds.

In one aspect, the nanofiber membrane is configured as a cosmetic patch, with pores facilitating more rapid and thorough release of active ingredients over time. The release rate for every gram of nanofiber membrane is at least 4 mg per hour, achieving 89% of the total active ingredient release within 24 hours.

In another aspect, the present invention provides an article having said nanofiber membrane.

In one aspect, the article is configured as an air filter having a reduced pressure drop of no more than 13 mmH₂O at a flow rate of 32 L/min, and a high filtration efficiency of at least 99.8% for particles of size around 0.3 m, with the efficiency tested over an area of 100 cm². The air filter is configured for use in a HVAC system or a face mask, or automobile filtration.

In one aspect, the article is a lateral flow assay device, with the nanofiber membrane employed in diagnostic test strips to reduce a capillary speed to no more than 40 cm/min, and enhance diagnostic sensitivity with a detection limit of at least lower than 30 ng/mL or achieving diagnostic sensitivity and specificity of 100%, when using Human Chorionic Gonadotropin (HCG) as an example.

In another aspect, the present invention provides a method for fabricating one or more dual-scale porous nanofibers, including: (1) providing a polymer solution comprising a water-miscible solvent, a water-immiscible solvent and a base polymer; and (2) electrospinning the polymer solution to form one or more nanofibers. The phase separation is induced during the electrospinning to create dual-scale pores in the one or more nanofibers to form the one or more dual-scale porous nanofibers with inter-fiber pores and surface pores structures. The one or more dual-scale porous nanofibers exhibit a uniform diameter distribution.

In one aspect, the water-immiscible solvent and the water-miscible solvent have distinct boiling points.

In one aspect, the phase separation is induced by differences in evaporation rates between the water-miscible solvent and the water-immiscible solvent during the electrospinning.

In one aspect, the water-immiscible solvent includes chloroform, dichloromethane, tetrahydrofuran, methyl ethyl ketone, or a combination thereof. The water-miscible solvent includes methanol, ethanol, isopropanol, dimethylformamide, acetone, dimethyl sulfoxide, formic acid, acetic acid, 1,1,1,3,3,3-hexafluoro-2-propanol, or a combination thereof. The base polymer includes PLA, PVDF, polycaprolactone, polyvinyl butyral, PS, PAN, or a combination thereof.

In comparison to prior art, this invention provides a more efficient, one-step fabrication process that avoids additional treatments, offering improvements in both performance and manufacturability.

### BRIEF DESCRIPTION OF THE DRAWINGS

Embodiments of the invention are described in more details hereinafter with reference to the drawings, in which:

FIG. 1 shows a schematic diagram illustrating the process of using two solvents to achieve phase separation in a polymer solution;

FIG. 2 shows the formation of pores in porous nanofibers through phase separation. The fast-evaporating solvent leaves the solution quickly, while the slow solvent droplets, combined with water vapor from the air, create pores in the polymer structure as the solution solidifies into nanofibers;

FIG. 3 shows a SEM image of the one or more dual-scale porous nanofibers with a diameter less than 500 nm and uniform diameter distribution;

FIG. 4 shows a comparison between smooth nanofibers and porous nanofibers in terms of filtration performance;

FIG. 5 shows graph comparing the release rates of active pharmaceutical ingredients (APIs) between smooth nanofibers and porous nanofibers;

FIG. 6A shows a lateral flow assay (LFA) device using nanofiber membranes to enhance diagnostic sensitivity; and

FIG. 6B shows a comparison of detection limits between traditional nitrocellulose membranes and the porous nanofiber membranes.

### DETAILED DESCRIPTION

In the following description, dual-scale porous nanofibers are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Conventional nanofibers typically lack sufficient surface porosity, which limits their efficiency in applications requiring rapid diffusion, high permeability, or controlled release. The present invention provides a nanofiber membrane with enhanced dual-scale porosity, improving performance in these applications.

More specifically, the present invention provides a nanofiber membrane with dual-scale porosity, it contains one or more dual-scale porous nanofibers. Each dual-scale porous nanofiber has a fiber body that interlaces with others to form a continuous porous network among the fiber bodies. The inter-fiber pores are distributed throughout the fiber body, while the surface pores are located on the outer surface of the fiber body.

The inter-fiber pores exhibit a uniform size distribution ranging from 100 nm to 900 nm, while the surface pores exhibit a distribution pore sizes ranging from 1 nm to 100 nm. This unique structure significantly improves permeability and diffusion rates compared to conventional membranes.

This invention introduces a unique structure where the nanofibers contain both inter-fiber and surface pores, resulting in a dual-scale porous network. The dual-scale porous network structure introduced in this invention is critical for enhancing various properties, such as permeability, diffusion control, and active ingredient release. Compared to conventional nanofiber membranes, which often have irregular or insufficient porosity, the present invention ensures a uniform and hierarchical pore distribution that enhances the membrane's efficiency in a variety of applications.

In one embodiment, the one or more dual-scale porous nanofibers are produced from a formulation including a water-immiscible solvent, a water-miscible solvent, and a base polymer. The water-immiscible solvent includes, but is not limited to, chloroform, dichloromethane, tetrahydrofuran, or methyl ethyl ketone. The water-miscible solvent includes, but is not limited to, methanol, ethanol, isopropanol, dimethylformamide, acetone, dimethyl sulfoxide, formic acid, acetic acid, or 1,1,1,3,3,3-hexafluoro-2-propanol. The base polymer includes, but is not limited to PLA, PVDF, polycaprolactone, polyvinyl butyral, PS, PAN. Table 1 provides an overview of various formulations containing the base polymer, a water-immiscible solvent, and a water-miscible solvent.

TABLE 1
Formulation of dual-scale porous nanofibers

| | Water-immiscible | Water-miscible |
|---|---|---|
| Base polymer | solvent | solvent |
| 5-20_g of poly(lactic | 50-90_mL of chloroform | 10-50_mL of ethanol |
| acid) | 50-90_mL of chloroform | 10-50_mL of |
| | | methanol |
| | 50-90_mL of chloroform | 10-50_mL of |
| | | isopropanol |
| 5-20_g of | 50-90_mL of chloroform | 10-50_mL of ethanol |
| polycaprolactone | 50-90_mL of chloroform | 10-50_mL of |
| | | methanol |
| | 50-90_mL of chloroform | 10-50_mL of |
| | | isopropanol |
| 5-10_g of polyvinyl | 80-95_mL of THF | 5-20_mL of DMSO |
| butyral | | |

The selection of solvent ratios plays a crucial role in controlling the phase separation behavior during electrospinning, which directly influences the porosity and uniformity of the resulting nanofiber membrane. In the polymer solution, the ratio of the water-immiscible solvent to the water-miscible solvent ranges from 1:1 to 16:1.

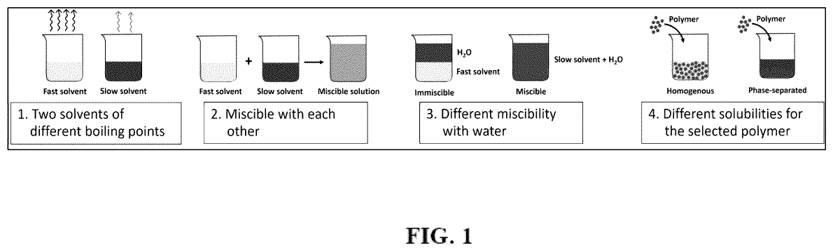

FIG. 1 shows the process of using two solvents to achieve phase separation in a polymer solution. The first solvent is a fast-evaporating solvent, and the second solvent is a slow-evaporating solvent. These solvents have different rates of evaporation due to their different boiling points. When these two solvents are mixed together, they form a single homogeneous solution, as they are miscible. The next step shows the behavior of the two solvents when mixed with water. The fast solvent is immiscible with water, meaning it does not mix with water, while the slow solvent is miscible with water, forming a homogeneous solution. In the final step, a polymer is added to the solvent mixture. The polymer dissolves uniformly in the solution when both solvents are present. However, as the solvents evaporate at different rates, the polymer becomes phase-separated, resulting in distinct regions due to the different solubilities of the polymer in the two solvents. This mechanism ensures a controlled and reproducible pore formation process, yielding a highly porous membrane with well-defined pore sizes.

In one embodiment, the two solvents have different boiling points. The water-immiscible solvent has a boiling points ranging from 40-80° C. The water-miscible solvent has a boiling points ranging from 60-200° C.

Many conventional nanofibers suffer from irregular or excessively large pore size distributions, leading to non-uniform performance in applications such as filtration, drug delivery, or tissue engineering. The inconsistency in pore size often results in inefficient filtration, unpredictable diffusion rates, and suboptimal performance in medical or industrial applications. The present invention overcomes these challenges by leveraging controlled phase separation to produce highly uniform nanofibers with predictable and reproducible properties.

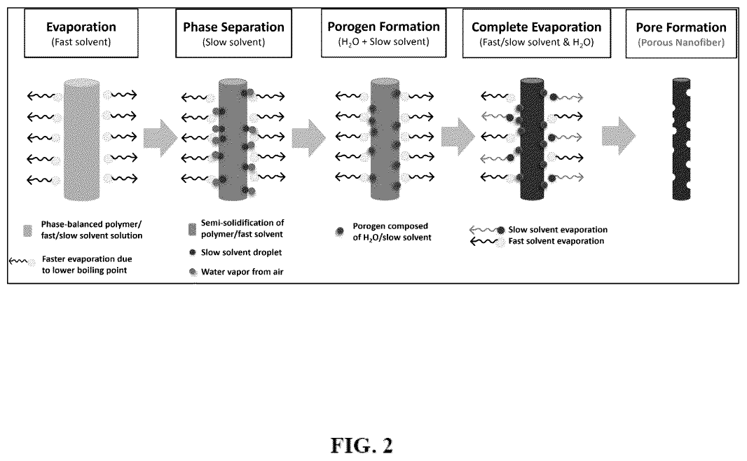

FIG. 2 shows the pore formation process in porous nanofibers through a phase-separation technique involving fast and slow solvents. As the fast-evaporating solvent evaporates rapidly, polymer-rich and polymer-poor phases emerge. The slow-evaporating solvent persists, forming porogens that create interconnected inter-fiber and surface pores. Upon complete evaporation, the final nanofibers exhibit a dual-scale porous network, optimizing permeability, diffusion rates, and mechanical properties.

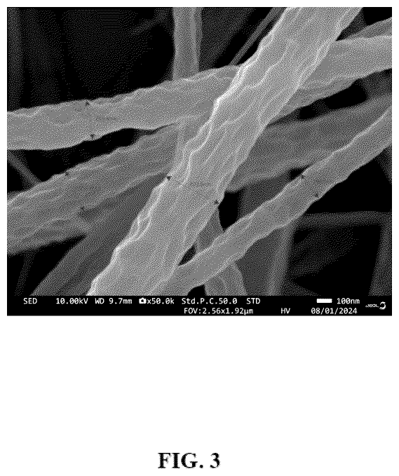

In one embodiment, the one or more dual-scale porous nanofibers have a diameter of less than 500 nm and an average pore size ranging from 10 nm to 50 nm (FIG. 3). The nanofibers have a uniform diameter distribution, which helps improve the consistency of the membrane's physical properties, such as mechanical strength and porosity.

Moreover, the invention provides a one-step phase-separation electrospinning method for fabricating nanofiber membrane. The method utilizes two solvents with different evaporation rates to create interconnected inter-fiber and surface pores, improving air permeability, diffusion rates, and pressure drop performance.

The present method avoids the need for additional surface treatments or multi-step processes, reducing manufacturing complexity and cost. The method leverages the evaporation rate differences between water-miscible and water-immiscible solvents to achieve the desired porosity, providing a scalable and efficient production technique.

In one embodiment, the electrospinning process is needleless electrospinning. The needleless electrospinning operates without the use of traditional needles. In this process, a polymer solution is placed on a flat or rotating surface, and a high voltage (50-100 kV) is applied, causing the liquid to form tiny droplets. These droplets are then stretched and solidified under the influence of the electric field, ultimately producing nanofibers. The working distance is typically 15-25 cm, with the process conducted at a temperature of 15-25° C. and humidity levels of 50-80%.

The key advantages of this method include higher production efficiency, as it can generate a large number of fibers simultaneously, making it ideal for large-scale industrial applications. For example, the membrane can function as a wound dressing, where its high porosity enhances absorption of wound exudate and promotes healing. Additionally, the nanofiber membrane can be utilized as a drug delivery system for controlled release of pharmaceutical compounds. The pores facilitate a precisely controlled release rate, ensuring sustained therapeutic efficacy. Moreover, the membrane can serve as a cosmetic patch, regulating the more rapid and thorough release of active ingredients.

Additionally, the needleless technique eliminates the common issue of needle clogging seen in conventional electrospinning, ensuring a more stable process. The fibers produced also exhibit more uniform distribution and diameter, which is beneficial for applications requiring precise fiber structures, such as filtration materials and medical dressings. For example, the use of the nanofiber membrane as an air filter achieves a reduced pressure drop of no more than 13 mmH₂O at a flow rate of 32 L/min, and a high filtration efficiency of at least 99.8% for particles of size around 0.3 m, with the efficiency tested over an area of 100 cm². The membrane is also adaptable for use in lateral flow assay devices, where it optimizes capillary speed to no more than 40 cm/min and enhances diagnostic sensitivity with a detection limit of at least lower than 30 ng/mL or achieving diagnostic sensitivity and specificity of 100%, when using Human Chorionic Gonadotropin (HCG) as an example.

Furthermore, this method offers greater flexibility in material selection, as it can process both solvent-based and water-soluble polymers. These advantages make needleless electrospinning highly promising in fields such as materials manufacturing and nanofiber production.

### EXAMPLE

### Example 1

### Fabrication of the Nanofiber Membrane

5-20 g of PLA, 50-90 mL of chloroform, and 10-50 mL of ethanol are mixed to obtain a polymer solution. The mixture is stirred using a magnetic stirrer at room temperature (approximately 25° C.) for 24 hours to ensure complete dissolution of PLA in the solvent mixture. The resulting polymer solution should be clear and homogeneous.

The needle-less electrospinning system consists of a wire electrode periodically coated with polymer solution by a moving reservoir. As the reservoir runs along the wire, a thin layer of the solution is coated on the wire, and due to the applied electric field (typically between 50 kV to 100 kV), multiple Taylor cones form spontaneously at various points on the cylinder's surface. The field strength must be optimized to ensure stable cone-jet formation, enabling the continuous extrusion of nanofibers. Unlike conventional needle-based electrospinning, this setup significantly increases production efficiency, allowing for the simultaneous formation of nanofibers from multiple sites. The reservoir's coating rate (10-60 Hz) and the distance between the electrode and the collector plate (15-25 cm) are critical in maintaining uniform fiber morphology. The resulting nanofibers exhibit a diameter of 100-500 nm with surface pores between 10 nm and 50 nm.

### Example 2

5-20 g of PLA, 50-90 mL of chloroform, and 10-50 mL of methanol are mixed to obtain a polymer solution. The resulting nanofibers exhibit a diameter of 100-500 nm with surface pores between 10 nm and 50 nm. The mixture is stirred using a magnetic stirrer at room temperature (approximately 25° C.) for 24 hours to ensure complete dissolution of PLA in the solvent mixture. The resulting polymer solution should be clear and homogeneous.

The needle-less electrospinning system consists of a wire electrode periodically coated with polymer solution by a moving reservoir. As the reservoir runs along the wire, a thin layer of the solution is coated on the wire, and due to the applied electric field (typically between 50 kV to 100 kV), multiple Taylor cones form spontaneously at various points on the cylinder's surface. The field strength must be optimized to ensure stable cone-jet formation, enabling the continuous extrusion of nanofibers. Unlike conventional needle-based electrospinning, this setup significantly increases production efficiency, allowing for the simultaneous formation of nanofibers from multiple sites. The reservoir's coating rate (10-60 Hz) and the distance between the electrode and the collector plate (15-25 cm) are critical in maintaining uniform fiber morphology. The resulting nanofibers exhibit a diameter of 100-500 nm with surface pores between 10 nm and 50 nm.

### Example 3

Application in Filtration with a Pressure Drop Lower than Conventional Nanofibers

The dual-scale porosity structure significantly improves the filtration efficiency by increasing the surface area for particle capture, while simultaneously reducing the pressure drop during filtration. This makes the membrane highly suitable for air filtration applications, such as in HVAC systems, face masks, and industrial filters, where high airflow and low resistance are critical.

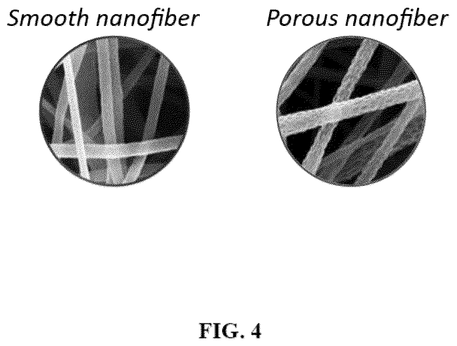

FIG. 4 and Table 2 compares the filtration performance of smooth nanofibers and porous nanofibers as filtration media. The two types of nanofibers are shown visually, with smooth nanofibers appearing as tightly packed fibers, while porous nanofibers have a more open, interconnected structure.

TABLE 2

| | Smooth nanofiber | Porous nanofiber |
|---|---|---|
| Filtration efficiency | 99.99% | 99.99% |
| Delta-P (mmH₂O) | 36.61 | 12.22 |

As shown in Table 2, both smooth nanofibers and porous nanofibers have a filtration efficiency of 99.99%. The pressure drop is lower for porous nanofibers (12.22 mmFHO) compared to smooth nanofibers (36.61 mmFHO), indicating that the porous structure allows air to pass through more easily, leading to a reduced pressure drop while maintaining similar filtration efficiency.

### Example 4

Application in Active Ingredient Release Platforms with Enhanced Diffusion Rates

The unique structure of the dual-scale porous nanofibers, with both surface pores and inter-fiber pores, significantly accelerates the diffusion of active ingredients in controlled-release systems.

Moreover, the dual-scale porosity also improves the efficiency of active ingredient loading, enabling higher API concentrations to be incorporated into the nanofibers without compromising release performance. This leads to a more efficient use of the active ingredient, reducing waste and ensuring consistent therapeutic effects.

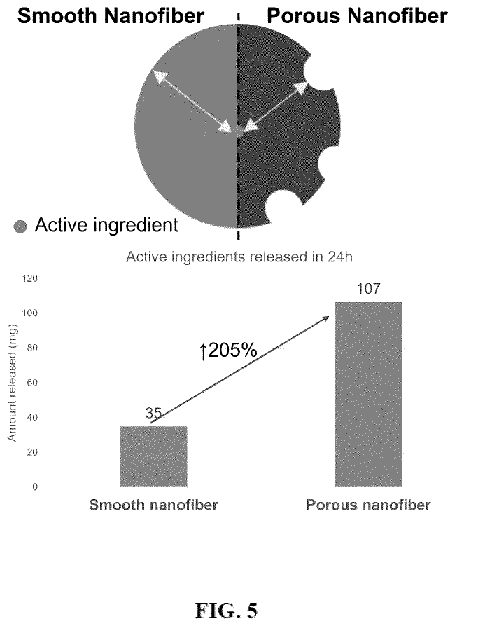

FIG. 5 compares the API-loaded amounts of smooth nanofibers and porous nanofibers. The results show that the porous nanofibers exhibit both a higher release of the APIs in 24 hours. This demonstrates the superior performance of porous nanofibers in delivering faster and more complete release of APIs compared to conventional smooth nanofiber structures, which are more limited in their ability to control and enhance drug diffusion. The improved performance in porous nanofibers is particularly beneficial in applications requiring rapid onset of action, as well as in systems which the API is expensive.

### Example 5

Application in Diagnostic Lateral Flow Strips with Improved Sensitivity Due to the Surface Porosity

For diagnostic applications, such as lateral flow assay test strips, the capillary speed of fluid flow through the nanofiber membrane is crucial. The dual-scale porosity allows fluids to flow through slowly, allowing more time for the antibodies to interact with the antigens, thus improving the sensitivity of diagnostic tests. This innovation addresses the limitations of conventional membranes, which often suffer from reduced detection accuracy.

The capillary speed in the nanofiber-based diagnostic strip is 0.56-0.63 mm/s, resulting in a decrease in limit of detection of at least 75% compared to a standard material with a capillary speed of 0.91-1.0 mm/s.

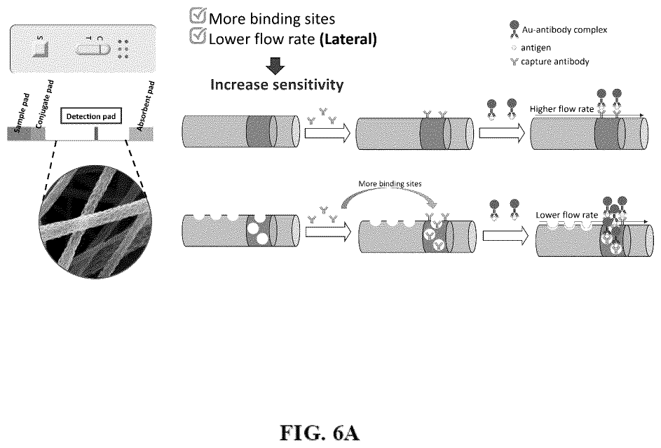

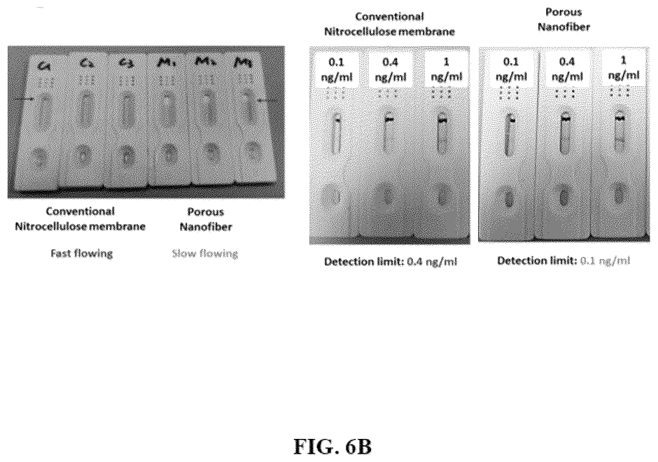

FIG. 6A depict a LFA device using nanofiber membranes to enhance sensitivity. The top left section shows a diagnostic test strip with key components such as the sample pad, conjugate pad, detection pad, and absorbent pad. The detection pad is highlighted, showing where the nanofiber membrane is applied. The zoomed-in section at the bottom left illustrates the nanofiber membrane of the present invention.

The right-hand side explains how the nanofiber membrane contributes to increased sensitivity. The pores in the membrane increase the number of available sites where the capture antibodies can bind with antigens. This improved surface area leads to greater analyte interaction. The membrane reduces the flow rate of the sample across the test strip. A lower flow rate provides more time for antigen-antibody interactions, leading to enhanced sensitivity.

The upper flow diagram demonstrates how a conventional nitrocellulose membrane with fewer binding sites and a higher flow rate may result in less efficient capture of the antigen-Au-antibody complexes. The lower flow diagram contrasts this by showing how the porous nanofiber membrane with more binding sites and a lower flow rate results in a greater capture of the complexes, thereby increasing the sensitivity of the diagnostic test.

FIG. 6B compares the detection limits of lateral flow assay devices using conventional nitrocellulose membranes and porous nanofiber membranes of the present invention. On the left side, the first set of test strips with nitrocellulose membranes (labeled “C”) shows fast-flowing behavior, while the second set with porous nanofiber membranes (labeled “M”) demonstrates slower flowing.

On the right side, a feasibility study shows the detection results of both membrane types at three different concentrations: 0.1 ng/ml, 0.4 ng/ml, and 1 ng/ml. The conventional nitrocellulose membrane is able to produce a clear visible positive result at 0.4 ng/ml but not at 0.1 ng/ml, thus having a detection limit of 0.4 ng/ml. In contrast, the porous nanofiber membrane is able to produce clear and visible positive results at concentration of 0.1 ng/ml, demonstrating the nanofiber membrane's capability to enhance diagnostic sensitivity by slowing down capillary flow and increasing binding capacity. This validates the application of the nanofiber membrane in lateral flow devices for more sensitive diagnostic tests.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, 5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “dual-scale porosity” refers to a nanofiber structure that possesses both inter-fiber pores (pores between individual nanofibers) and surface pores (pores on the fiber surface). This combination enhances permeability and diffusion, making the material suitable for applications that require efficient transport of fluids or gases.

The term “inter-fiber pores” refers to the spaces or voids located between individual nanofibers within a nanofiber mesh. These pores contribute to the bulk porosity of the material, allowing for the passage of air, fluids, or particles through the nanofiber network, which can improve filtration and gas exchange properties.

The term “surface pores” refers to the pores that are located on the outer surface of individual nanofibers. These pores improve diffusion rates by providing increased surface area and pathways for molecules to penetrate or be transported across the material, enhancing its performance in applications like tissue engineering and sensors.

The term “needle-less electrospinning” refers to a high-throughput electrospinning technique that eliminates the use of individual needles for fiber formation. This method enables the large-scale production of nanofibers by utilizing an alternative setup that can produce fibers in bulk, making it more efficient for industrial applications.

The term “phase separation” refers to a process that occurs during solvent evaporation, in which the polymer solution separates into distinct phases, leading to the formation of pores within the fibers. This phenomenon can be controlled to achieve specific pore sizes and structures within the nanofibers, which are crucial for enhancing material properties such as porosity and permeability.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A nanofiber membrane with dual-scale porosity, comprising one or more dual-scale porous nanofibers, wherein each dual-scale porous nanofiber comprises a fiber body having a continuous porous network with interconnected inter-fiber pores and fiber surface pores, and wherein the inter-fiber pores are distributed throughout the fiber body, and the surface pores are located on the outer surface of the fiber body, wherein the inter-fiber pores exhibit a uniform size distribution ranging from 100 nm to 900 nm, and the surface pores exhibit a uniform size distribution ranging from 1 nm to 100 nm.

2. The nanofiber membrane of claim 1, wherein the one or more dual-scale porous nanofibers are produced from a formulation, by weight, comprising 45-90% of water-immiscible solvent, 5-45% of water-miscible solvent, and 5-20% of base polymer.

3. The nanofiber membrane of claim 2, wherein the water-immiscible solvent has a boiling point ranging from 40-80° C., and the water-miscible solvent has a boiling point ranging from 60-200° C.

4. The nanofiber membrane of claim 2, wherein the water-immiscible solvent comprises chloroform, dichloromethane, tetrahydrofuran, methyl ethyl ketone, or a combination thereof.

5. The nanofiber membrane of claim 2, wherein the water-miscible solvent comprises methanol, ethanol, isopropanol, dimethylformamide, acetone, dimethyl sulfoxide, formic acid, acetic acid, 1,1,1,3,3,3-hexafluoro-2-propanol, or a combination thereof.

6. The nanofiber membrane of claim 2, wherein the base polymer comprises polylactic acid (PLA), polyvinylidene fluoride (PVDF), polycaprolactone, polyvinyl butyral, polystyrene (PS), polyacrylonitrile (PAN), or a combination thereof.

7. The nanofiber membrane of claim 1, wherein the specific area of the one or more dual-scale porous nanofibers is at least 30 m²/g.

8. The nanofiber membrane of claim 1, wherein the one or more dual-scale porous nanofibers are formed via needle-less electrospinning.

9. The nanofiber membrane of claim 1, wherein the nanofiber membrane is configured as a wound dressing, enhancing absorption of wound exudate and promoting healing.

10. The nanofiber membrane of claim 1, wherein the nanofiber membrane is configured as a drug delivery system for controlled release of pharmaceutical compounds.

11. The nanofiber membrane of claim 1, wherein the nanofiber membrane is configured as a cosmetic patch, with pores facilitating more rapid and thorough release of active ingredients over time, wherein the release rate for every gram of nanofiber membrane is at least 4 mg per hour, achieving 89% of the total active ingredient release within 24 hours.

12. An article, comprising the nanofiber membrane of claim 1.

13. The article of claim 12, wherein the article is configured as an air filter or a lateral flow assay device, wherein the air filter has a reduced pressure drop of no more than 13 mmH₂O at a flow rate of 32 L/min, and a high filtration efficiency of 99.8% for particles of size of approximately 0.3 m, with the efficiency tested over an area of 100 cm²; and wherein the lateral flow assay device with the nanofiber membrane employed in diagnostic test strips reduce a capillary speed to no more than 40 cm/min, and enhance diagnostic sensitivity with a detection limit of at least lower than 30 ng/mL or achieving diagnostic sensitivity and specificity of 100%, when using Human Chorionic Gonadotropin (HCG).

14. A method for fabricating one or more dual-scale porous nanofibers, comprising the steps of:
providing a polymer solution comprising a water-miscible solvent, a water-immiscible solvent and a base polymer; and
electrospinning the polymer solution to form one or more nanofibers, wherein phase separation is induced during the electrospinning to create dual-scale pores in the one or more nanofibers to form the one or more dual-scale porous nanofibers with inter-fiber pores and surface pores structures,
wherein the one or more dual-scale porous nanofibers exhibit a uniform diameter distribution.

15. The method of claim 14, wherein the phase separation is induced by differences in evaporation rates between the water-miscible solvent and the water-immiscible solvent during the electrospinning.

16. The method of claim 14, wherein the water-immiscible solvent has a boiling point ranging from 40-80° C., and the water-miscible solvent has a boiling point ranging from 60-200° C.

17. The method of claim 14, wherein the water-immiscible solvent comprises chloroform, dichloromethane, tetrahydrofuran, methyl ethyl ketone, or a combination thereof.

18. The method of claim 14, wherein the water-miscible solvent comprises methanol, ethanol, isopropanol, dimethylformamide, acetone, dimethyl sulfoxide, formic acid, acetic acid, 1,1,1,3,3,3-hexafluoro-2-propanol, or a combination thereof.

19. The method of claim 14, wherein the base polymer comprises polylactic acid (PLA), polyvinylidene fluoride (PVDF), polycaprolactone, polyvinyl butyral, polystyrene (PS), polyacrylonitrile (PAN), or a combination thereof.
